(19) United States
(12) Patent Application Publication
(10) Pub. No.: US 2026/0329718 A1
(43) Pub. Date: Oct. 22, 2026

(54) HARDWARE TRACE BUFFER MODULE CONNECTABLE TO A ZERO-KNOWLEDGE VIRTUAL MACHINE FOR GENERATING A ZK WITNESS TRACE

(71) Applicant: Ingonyama Ltd., Petach Tikva (IL)

(72) Inventors: Omer SHLOMOVITS, Petach Tikva (IL); Michael ASA, Kfar Sava (IL); Daniel SHTERMAN, Petach Tikva (IL); Karthik INBASEKAR, Tel Aviv (IL)

(73) Assignee: Ingonyama Ltd., Petach Tikva (IL)

(21) Appl. No.: 19/184,504

(22) Filed: Apr. 21, 2025

(51) Int. Cl. G06F 11/34; G06F 11/3604

(52) U.S. Cl. CPC G06F 11/348; G06F 11/3608

(57) ABSTRACT

A hardware trace buffer module having connections for coupling to a processor that is configured to run a zero-knowledge virtual machine, the trace buffer module being configurable by a prover to store data identifying traceable instructions executed by the processor that are to be traced for use by a proof generator, the trace buffer module being responsive to completion of successive instructions executed by the processor, for accessing memory in the processor and for each traceable instruction recording a respective state of the processor in a trace buffer memory of the trace buffer module, the trace buffer module being couplable to a proof generator configured to compute a proof from the successive states in the trace buffer memory.

### FIELD OF THE INVENTION

This invention relates to witness generation.

### BACKGROUND OF THE INVENTION

Zero knowledge (ZK) proofs are a cryptographic technique that allows one party (the prover) to prove to another party (the verifier) that they know a piece of information without revealing the information itself. In the common case, there is a function described as a computer program with inputs and outputs, and the prover provides a proof that they know a certain input to that program such that it produces an output of zero.

The generation of a zero knowledge proof (executed by the prover side) is composed of two significant processing phases. The first phase is a witness generation, which involves running the program together with the secret input and generating a vector composed of the secret input, the public inputs, and a trace of the intermediate calculation results. The second phase is proof generation, which works on the witness and processes it based on the ZK system. Proof generation has always been identified as a bottleneck and the phase with heavy processing demands. This is why, in recent years, the industry's focus has been directed toward accelerating this phase through more sophisticated software and advanced, dedicated hardware. This has led to a significant and progressive decrease in proof generation processing time.

Witness generation, on the other hand, has attracted less attention and has been accelerated more slowly. Additionally, witness generation usually involves serial calculations (running the program one instruction after the other), making the acceleration of this process more complex. As a result, it may be observed that the relative processing time of proof generation decreases, while the relative time for witness generation increases. A good example is RISC Zero's zero-knowledge virtual machine (zkVM), where the witness generation phase takes 30%-50% of the total process.

The core of a zkVM application is the guest program. The guest program is the part of the application that gets proven. In a conventional software-implementation, to prove correct execution of the guest program the following steps are required:
1. The guest program is compiled to an ELF binary, i.e. Executable and Linkable Format.
2. The executor runs the ELF binary and records the session.
3. The prover checks and proves the validity of the session, outputting a proof.

RISC Zero provides an open-source Zero-Knowledge Virtual Machine (ZKVM) that allows executing arbitrary programs inside a ZK-proof system, proving correct execution without revealing private inputs. For the sake of brevity and clarity, we will refer to the RISC Zero system by the company name. RISC Zero works by executing a program inside a RISC-V emulator and proving the execution trace. RISC Zero is a ZK system based on RISC-V CPU architecture, which is an open-source CPU architecture. RISC-V works by starting with the description of a program using a high-level language and compiling that program into RISC-V machine code (assembly). This program has inputs and outputs and is known to both the prover and the verifier. When a program runs on a machine, the execution trace (or simply, the trace) is a record of the full state of the machine at each clock cycle of the computation. Commonly, an execution trace is represented as a rectangular array, where each row shows the complete state of the machine at a given moment in time, and each column shows a temporal record of some particular aspect of the computation (say, the value stored in a particular RISC-V register) at each clock cycle. The prover then generates the witness by running the program on its secret input and sampling the state of the machine after every machine instruction executed. This state encapsulates the value of each register and the data memory state of the machine. It should be noted that there are some implementations of snark that do not require a secret input, and the prover runs the program based only on public data. In such implementations, the proof still asserts the prover's authenticity by demonstrating that he ran the public program correctly and thus convinces the verifier that the results are trustworthy without the need for the verifier to run the program independently. For the avoidance of doubt, CPUs that run proofs not requiring use of a secret input still fall within the ambit of zero-knowledge virtual machines.

The trace, together with the secret input and other public inputs if they exist, serves as the witness and is provided to the next phase which is the proof generation. The witness is a vector of steps that are carried out by the function. By way of example, we can consider a function that operates on three input variables a, b, c in the following manner:

| | |
|---|---|
| f(a, b, c)= | a |
| a + b = d | b |
| d*c = f | c |
| . | d |
| . | f |
| . | |
| =>output | Output |

The column at the right is a witness that shows the result of each intermediate step. So if the prover can prove that at each step, he obtained the same output as the verifier, this indicates that the prover knew the secret even though it is neither known nor revealed to the verifier.

In practice, the verifier need not interrogate the complete vector: typically, it interrogates only a specific step or a few steps, and if the answer corresponds to that of the verifier and the end result for ƒ(a, b, c) is the same, we can assume that the prover did indeed operate ƒ(a, b, c) using the secret input as one of the function's arguments.

Conventional witness generators run the function using software. To this end, they compile the function to produce assembly. The assembly code is specific to the CPU on which the function is run—but will be the same for the same function across multiple CPUs that conform to the same industry standard. So if the function code is compiled for Intel, the identical assembler code will be obtained as for AMD providing that the same compiler is used because both use the same X86 architecture. However, the resulting code would not operate on architectures using different processors or different compilers. For the sake of completeness, it should be noted that even for the same processor, different compilers may be available, each being optimized differently and producing different assembly from the same high-level code. Therefore, it is essential that the same compiler be used for both the prover and the verifier.

The corresponding witness trace for the assembly code is of course much longer than for the uncompiled function because assembly is much lower level and therefore has many more intermediate steps. The actual witness trace is thus of the form:

| Instruction no. | State: |
|---|---|
| 0 | Reg 1 = 6 |
| 1 | Reg 2 = 8 |
| 2 | Reg 1 = 10 |
| 3 | Reg 2 = 8 |

At each instruction step, we can determine the value of each of the CPU's registers. For a 32-bit Operating System there are 32 registers and for a 64-bit Operating System there are 64 registers. The values of the registers at each instruction step constitute the state of the machine, and the cumulative states of the machine during execution of the proof constitute the witness. The witness may contain millions of states, whose values are determined by the secret input, which serves as an argument to the function computed by the prover. The witness is passed to a proof generator, which computes an output (proof) based on the millions of successive states constituting the witness and the proof is then communicated to the verifier. A mismatch in even a single state of the witness will result in the proof generator computing a different proof. Consequently, the proof serves to verify that the witness is authentic. The verifier authenticates the prover by checking a cryptographic proof that is mathematically guaranteed to be valid if and only if the prover knows the correct secret input. The proof itself reveals nothing about the secret input owing to zero-knowledge properties, thus ensuring privacy while maintaining verifiability. Strictly speaking, the proof serves to verify that the witness is potentially authentic since a different secret input could theoretically result in the proof generator producing the same proof. However, the probability that this will occur owing to an inauthentic prover using an invalid secret is so infinitesimally small as to be negligible. To all intents and purposes, if the verifier determines that the proof is valid, the witness and hence the prover may be established as authentic.

Known architectures for running the ZK algorithm do not provide access to the registers, so it is not possible to access the witness in hardware. Currently, the only way to obtain the state of the registers at any given point of execution is to simulate the architecture on a different computer, execute the program and sample the simulator's state after each instruction. Since the simulator is software running on a CPU, it operates two orders of magnitude slower than real hardware, e.g., a RISC-V ASIC running the original program.

It would clearly be advantageous if the state of the registers could be monitored directly in hardware, but no provision currently exists that allows this.

### SUMMARY OF THE INVENTION

The invention addresses this need by providing a hardware trace buffer module having connections for coupling to a processor that is configured to run a zero-knowledge virtual machine. The trace buffer module is configurable by a prover to store data identifying traceable instructions executed by the processor that are to be traced for use by a proof generator. The trace buffer module is responsive to completion of successive instructions executed by the processor, for accessing memory in the processor and for each traceable instruction recording a respective state of the processor in a trace buffer memory of the trace buffer module, the trace buffer module being couplable to a proof generator configured to compute a proof from the successive states in the trace buffer memory.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic diagram of a trace buffer module according to an embodiment of the invention integrated with a CPU core and optionally a proof generator;

FIG. 2 shows a detail of the internal architecture of the CPU that is rendered accessible for coupling to the trace buffer module;

FIG. 3 is a high level diagram of the trace buffer module;

FIG. 4 is a block diagram showing the structure of each state stored in the trace buffer memory;

FIG. 5 shows schematically an implementation of the trace buffer memory, and

FIGS. 6 and 7 are flow chart showing operation of the trace buffer module.

### DETAILED DESCRIPTION OF EMBODIMENTS

RISC-V is an open source instruction set for computer processors. Other known and proprietary instruction sets are X86 used by Intel, AMD and other computer CPU manufacturers and Arm used by smartphones and other devices. Although the invention is described with particular reference to RISC-V, it is to be understood that the principles of the invention are applicable to any architecture, provided that the hardware can be modified in accordance with the invention to provide register access to the witness generator.

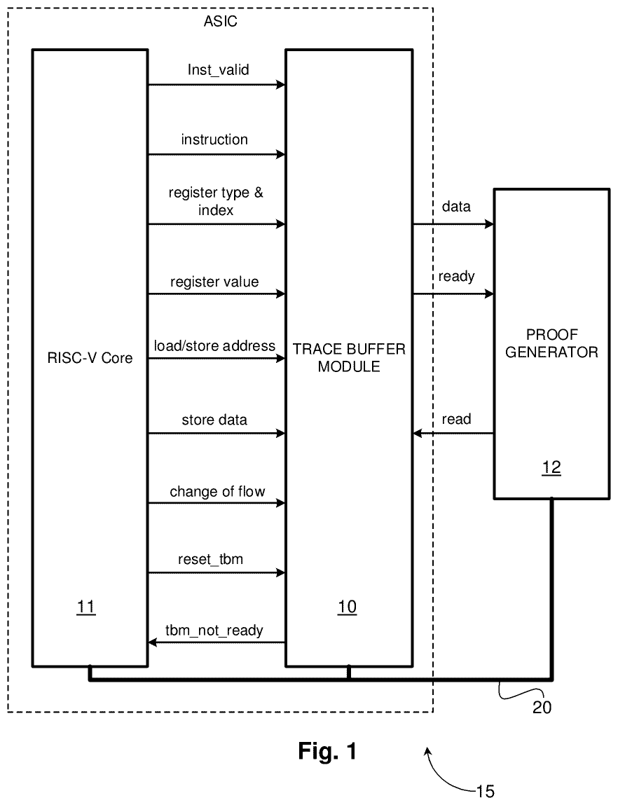

FIG. 1 shows the functionality of a trace buffer module 10 coupled to a CPU core 11. Preferably the two are integrated on the same silicon die to form a system on a chip (SoC) 15 because the connectivity between them involves more than just a simple CPU core pinout. The SoC 15 or its sub-units may be implemented by an application-specific integrated circuit (ASIC) or a field-programmable gate array (FPGA). Specifically, additional signals need to be incorporated into the pinout of the CPU core 11 and most of the signals need to be generated inside the CPU core. Also shown is a proof generator 12, which may be independent of the trace buffer module 10, although it, too, is preferably a sub-unit within the SoC 15 integrated on the same silicon die as the trace buffer module 10 and the CPU core 11. Data transfer between all three sub-units is facilitated over a common peripheral bus 20. Also from a security point of view and also to optimize the rate of data transfer from the trace buffer module to the proof generator 12, it is better that the CPU that generates the trace and the CPU/logic that generates the proof using this trace will reside on the same silicon because the secret input forms part of the trace and is therefore accessible to the proof generator 12. However, this is not an absolute requirement and the invention can be implemented by wire-coupling an external trace buffer module 10 to both the CPU core 11 and an independent proof generator. For example, the proof generation can be implemented by a remote service such as Bonsai, which lets users generate proofs for their zkVM applications, without using their own hardware for proof generation. Users specify which zkVM application they want to run, as well as the inputs to the program, and Bonsai returns a proof. In any event, although for completeness the proof generator is shown in FIG. 1, it is not part of the present invention, which relates to the trace buffer module and the manner in which the trace is generated during execution of the program by the CPU core and stored in the trace buffer module.

The pin layout shown in FIG. 1 is not inherent to the RISC-V architecture and denotes functionality that must be added when designing the CPU core 11. While this can be done by the manufacturer for any CPU design, an advantage of using RISC-V is that it is open-source and therefore lends itself to modification by the CPU designer. Those skilled in the art of IC design will appreciate that this is a well-known technique, but for the sake of completeness we will summarize the procedure. The RISC-V architecture is encoded using a hardware description language such as Verilog, which is commonly used to design and model digital circuits.

Verilog describes hardware behavior and structure such as hardware components that operate in parallel, reflecting the nature of physical circuits. The Verilog code describes what the circuit does using algorithms, describes data flow and clocked processes and describes hardware as a collection of interconnected gates. Verilog code can be converted into a netlist, which is a representation of the circuit that can be implemented on an FPGA or ASIC. An IC designer familiar with Verilog can easily identify nodes in the circuit that can be used to access internal registers and data lines even if they are not externally accessible in the final circuit. Such nodes can be modified in code to provide external access, so that internal functionality of the circuit that is not normally accessible in hardware can be made accessible. An engineer can identify where specific registers are declared or accessed in the Verilog code and can use a parser to locate the address bus or similar constructs. The Verilog code can then be parsed to extract the specific address lines for the registers of interest and wire definitions can be inserted for the address lines in the Verilog module, which can be modified to connect these wires to the trace buffer module 10.

Before describing in detail the inputs to the trace buffer module, it is emphasized that the following description relates to a specific embodiment, which assumes that the trace buffer memory, which is yet to be described, is not of sufficient capacity to store the complete trace. At the end of the detailed description, we shall provide some guidelines for a more simplified configuration, which can be implemented if the trace buffer memory has sufficient capacity to hold the complete trace.

Thus, referring to FIG. 1 the RISC-V core is modified to provide the following outputs:
inst_valid: This goes HIGH for a single clock when a valid instruction is completed by the CPU core 11. The manner in which completion of a valid instruction is identified depends on the core architecture. The number of clock cycles required for an instruction to be completed depends on the complexity of the instruction. For example, division may require 10-40 cycles in simple cores and 4-20 cycles in optimized/pipelined designs. The trace needs to record the change in the register only on actual completion of an operation. It will be understood by those skilled in the art that completion of an instruction may be signified using other mechanisms. For example, in a pipelined CPU, detecting when an instruction completes typically means detecting when it reaches the write-back (WB) stage. For simple 5-stage pipelines (IF, ID, EX, MEM, WB) an instruction is completed when it writes its result back to the register file (WB stage). A 5-stage pipeline is characterized as follows:

| Stage | Name | What Happens Here |
|---|---|---|
| IF | Instruction Fetch | Fetch the instruction from memory |
| ID | Instruction Decode/ | Decode the instruction and read source |
| | Register Fetch | registers |
| EX | Execute/Address | Perform ALU operations or calculate |
| | Calculation | memory address |
| MEM | Memory Access | Read/write data from/to memory (for a |
| | | load/store instruction) |
| WB | Write Back | Write the result back to |
| | | the register file |

Completion of an instruction can therefore be detected by:
Monitoring a signal like reg_write_en along with the destination register; or
Checking the instruction in the WB stage using a pipeline register or control signal.

For instructions implemented as a multi-cycle operation:
The instruction enters the EX stage (Execute).
Instead of completing in a single clock cycle, the EX stage holds the instruction for multiple cycles while the instruction runs.
The instruction does not advance to the MEM or WB stages until the division is done.

During the design of the CPU, the Verilog file can be modified to provide access to the WB register, thus facilitating detection of a completed instruction.
instruction: The witness is a compilation of instructions and corresponding machine states. So we need to access each instruction from the CPU core and pass it to the trace buffer module 10. As will be explained below in greater detail, the instruction is identified by an opcode and corresponding arguments. The opcode specifies the operation to be performed, typically by an arithmetic logic unit (ALU). Opcodes can be of the form ADD, SUBTRACT, MOV, JMP etc. Although the line labeled ‘instruction’ in FIG. 1 is shown as a single line, in practice it is a multi-bit connection requiring a separate line for each instruction bit, the number of lines being typically 32 or 64, depending on the CPU architecture and each line being ‘0’ or ‘1’. Whenever the CPU places a new instruction on the stack, the instruction lines reflect the opcode and associated arguments. But as noted above, we cannot write this to the trace buffer memory until the instruction is fully executed, since until completion the result that forms part of the trace is not yet known. In a typical hardware implementation, inst_valid is a first input to a 2-input AND gate whose second input is connected to the clock. The output of the AND gate serves as an enable signal to the registers in the trace buffer memory, each of which is constituted by a D Flip Flop with enable. If inst_valid is LOW, the registers in the trace buffer memory hold their previous value. The trace buffer memory captures the instruction data on the next clock edge only when inst_valid is HIGH. For the sake of abundant clarity, it is noted that while proof generation using the zk-snark protocol requires the opcode and arguments associated with an instruction as part of the trace, other protocols may not require these data.

Instructions can be of three types: LOAD, STORE and ALU. LOAD and STORE are opposite operations used to move data between external memory and registers in the CPU. ALU manipulates data between registers and does not access RAM. LOAD transfers data from external memory (RAM) to a register while STORE transfers data from a register to RAM. CPUs have a limited amount of internal memory in the form of registers that during program execution store instructions and results of executing the instructions. Instructions and results that are not currently required are off-loaded into RAM and fetched when required. The transfer of data to and from RAM is handled by providing the address of the register or RAM where the data is to be transferred. The witness generator needs to maintain a record of the status of all registers and external memory (RAM).
register type and index: Register type can be:
   Floating Point register
   Integer register
   Control register

In a 64-bit operating system, there are 64 separate registers for each register type. Index is the index of the register of the specified register type.
load/store address: Both the source address and the destination address must be specified. For example, lw x5, 0(x10) loads a 32-bit word from memory address in x10 into register x5, while sw x5, 0(x10) does the opposite.
store data: this is the data that is stored from the CPU memory into the external memory (RAM)
change of flow: an indication as to whether or not a change of flow instruction such as JMP, BRANCH has been executed. For example, if a branch instruction is executed, we need to jump to the address execute the next instruction.
reset_tbm: In the event of a new trace of a new guest program in the CPU core, reset_tbm goes HIGH, which initializes the trace buffer memory and aborts the trace until reset_tbm goes LOW when the trace restarts.
tbm_not_ready: The proof generator must have access to the complete history of machine states during execution of the proof. In practice this requires that millions of states must be compiled, while the size of the trace buffer memory is typically insufficient to stores all these states simultaneously. This requires that the proof generator works in a pipeline mode of operation where initial states are stored and intermediate computations are performed on these states and the results fed to the proof generator. The intermediate computations usually involve a hash function of multiple current states, so that after each iteration the result of the hash function serves as an input to the next iteration and the initial states can be discarded. This process is repeated iteratively until all states are processed and obviates the need for the trace buffer memory to accommodate all states simultaneously. However, until all current states in the trace buffer memory are processed and the results passed to the proof generator, we may reach saturation where the trace buffer memory is full. When this happens, tbm_not_ready goes HIGH and prevents the CPU core from feeding further instructions to the trace buffer module. When the trace buffer memory transfers data to the proof generator, thereby releasing memory, tbm_not_ready goes LOW and data transfer is resumed.

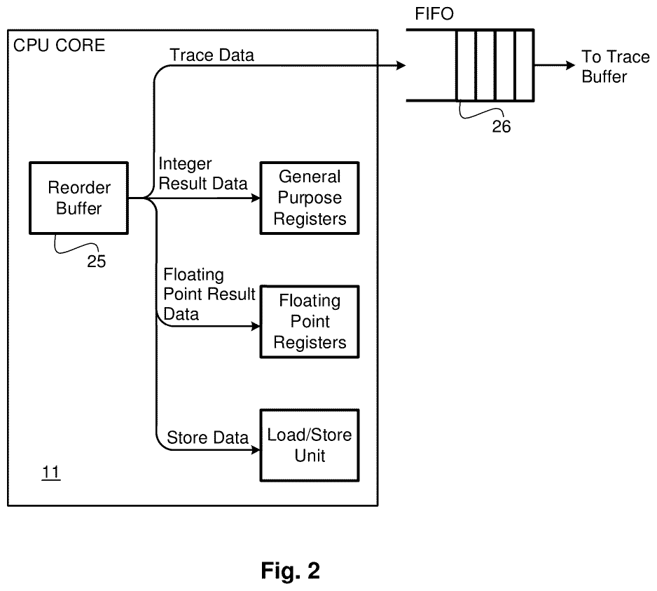

FIG. 2 shows the relevant functionality of a high-performance out-of-order CPU core. A Reorder Buffer 25 is provided to maintain program order while allowing instructions to execute out of order. It ensures correct execution by reordering the results before committing them to the architectural state (registers and memory). The Reorder Buffer serves three key functions in an out-of-order execution CPU:
1. Maintaining Program Order: Although instructions execute out of order, the Reorder Buffer ensures they retire (commit) in the order specified by the program.
2. Handling Speculative Execution: It allows instructions to execute speculatively and only updates the architectural state when the instruction is safe to commit.
3. Supporting Precise Exceptions: If an exception (e.g., division by zero) occurs, the Reorder Buffer ensures that all previous instructions are committed, and later instructions are discarded, restoring a valid program state.

The Reorder Buffer is typically implemented as a circular queue (FIFO) with the following fields for each instruction:
Instruction ID: Identifies the instruction.
Destination Register: The register to be updated once the instruction commits.
Result Value: Stores the computed result.
Ready Bit: Indicates whether the instruction has finished execution.
Exception Bit: Flags whether an exception occurred.
Program Order Index: Ensures instructions retire in the correct order.

Operation of the Reorder Buffer is as follows:
1. Instruction Dispatch (Issue Stage)
   The CPU issues an instruction and allocates an entry in the Reorder Buffer.
   If the instruction writes to a register, it is marked as pending. As shown in FIG. 2, different registers are provided for storing different types of data, such as general purpose for integer type data, floating point for non-integer types and load/store for interaction with external memory.
2. Instruction Execution
   The instruction is executed by a functional unit.
   Once execution finishes, the result is stored in the Reorder Buffer entry, and the Ready Bit is set.
3. Instruction Commit (Retirement Stage)
   Instructions are retired in order from the Reorder Buffer.
   If the instruction has completed and there are no exceptions, the result is written to the register file.
   If an exception occurs, all later instructions in the Reorder Buffer are flushed.

By way of example, consider the following instructions:
1. R1=R2+R3
2. R4=R5*R6
3. R7=Mem[R8](Load)

These instructions may be executed out of order in the following manner:

Out-of-Order Execution in Reorder Buffer (ROB)

| ROB Entry | Instruction | Executed? | Ready? | Committed? |
|---|---|---|---|---|
| 1 | R1 = R2 + R3 | ✓ | ✓ | ✓ |
| 2 | R4 = R5 * R6 | ✓ | ✓ | ✓ |
| 3 | R7 = Mem[R8] | X (waiting on | X | X |
| | | memory) | | |

The first two instructions complete execution early and are marked ready.
The third instruction (load) is still waiting for memory.
The CPU commits only the first two instructions while waiting for the third.

The Reorder Buffer plays a crucial role in handling branch prediction and memory disambiguation in an out-of-order processor. These two mechanisms work together to optimize instruction execution while maintaining correctness. The output of the reorder buffer is relevant at the commit stage of the instruction flow. Therefore, the results of the instructions that are written into the General Purpose Registers (GPR) file, Floating Point Registers (FPR) file and Load/Store Unit (LSU) will not later be canceled because of any branch miss prediction, interrupt or exception.

Note that for multicore and multithreading CPU's the mechanism above should be duplicated according to the number of cores and/or threads.

A FIFO 26 on a path to the Trace Buffer is provided to cater for the situation that the Reorder buffer commits more than a single instruction on a single clock, thereby creating a bottleneck because the output to the Trace Buffer is a single instruction per clock cycle. This requires that on average the CPU should not commit more than a single instruction per clock cycle. The FIFO serves to compensate for bursts of committed instructions arriving from the Reorder buffer to the trace buffer that cannot be immediately accommodated by the trace buffer memory. In this case the excess states are retained in the FIFO until the trace data is passed to the proof generator, thus clearing space in the trace buffer memory for new data.

### Trace Buffer Module

The description of the Trace Buffer Module below is suitable for a CPU core that has a single integer ALU and a single floating point unit, the latter of which is optional. In the case of a CPU core with multi-scalar issue capability the required signals and logic should be duplicated accordingly.

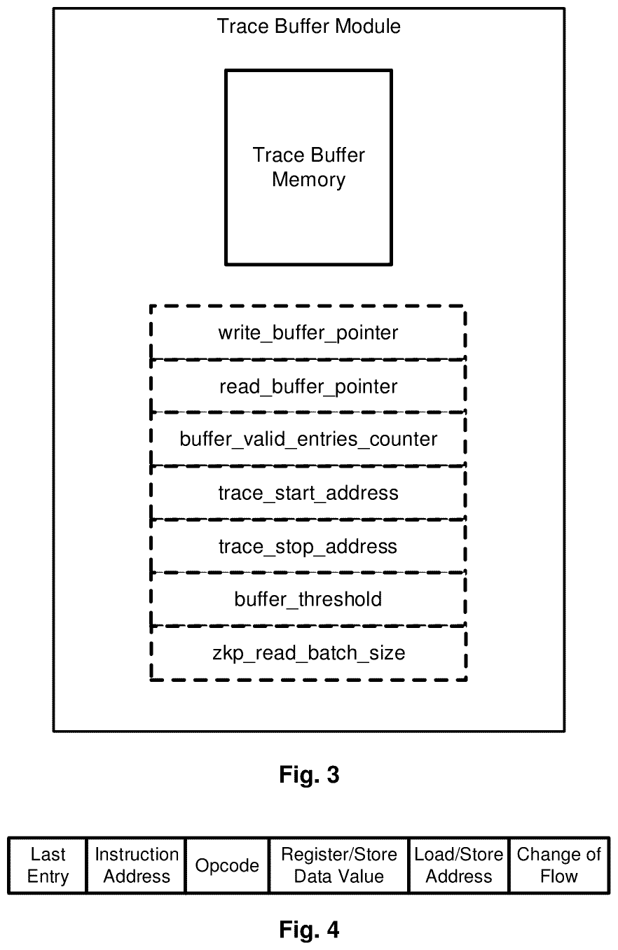

FIG. 3 is a high level diagram of the Trace Buffer Module. The trace buffer (trace_buffer) memory is implemented by using a two-port memory SRAM (i.e. one write port and one read port). The write port is used to store the traced instructions data, while the read port is used by the proof generator to read this data. The width of the trace buffer memory depends on the actual implementation of the CPU core (e.g. whether it is 32b or 64b integer core and if it has a Floating Point Unit). It also depends on the exact types of data that should be traced for particular ZK proof. The Trace Buffer Module contains the following registers:
Trace_start_address and trace_stop_address: used to identify the code section in memory allocated to the zk-proof and informs the trace buffer module when to start the trace operation and when to stop it by comparing the valid inst_addr bus against these registers. These registers are accessible by the peripheral bus 20. It should be noted that while the CPU core 11 runs the ZK proof it may also be running other tasks, such as word-processing, Internet browser, email and so on. All of these tasks execute in parallel in a multi-tasking environment. In particular, RISC-V is a conventional CPU core in all respects other than its being open-source. The RISC-V protocol needs access to the address of the instruction since each task executing in a multi-task CPU is allocated a block of instruction addresses for each task. This is done by the operating system on program execution and is generally random so that each time a given program is executed, it will be allocated a different instruction address block. The address of the instruction thus serves to identify the task and only when the instruction's address falls within the assigned address block does it relate to a traceable instruction.

Because allocation of instruction addresses is performed randomly by the operating system, the address block holding the zk-proof instructions cannot be known in advance. In order for the trace buffer module to be apprised of the start and end of the code section in memory, the user (prover) can load the program and then use a command-line tool such as GDB that shows the memory mapping and section addresses. Alternatively, the RISC-V architecture can be modified by the designer to provide access to the start and end of the code section in memory and the relevant data can be written to the appropriate registers in the trace buffer module via the peripheral bus.
Buffer_threshold: this establishes the maximum number of trace records that can be accommodated in the trace buffer memory and serves to generate the tbm_not_ready (trace buffer not ready) signal toward the CPU in order to suspend the execution of the traced program until the trace buffer module will have enough free space to continue the trace operation. Resumption will occur after the logic that implements the proof generator will read some data from the buffer, thereby freeing space in the trace buffer memory. Buffer_threshold is set during configuration and stored in a register that is accessible by the SoC peripheral bus. Note the tbm_not_ready signal could be connected to the interrupt input of the CPU.

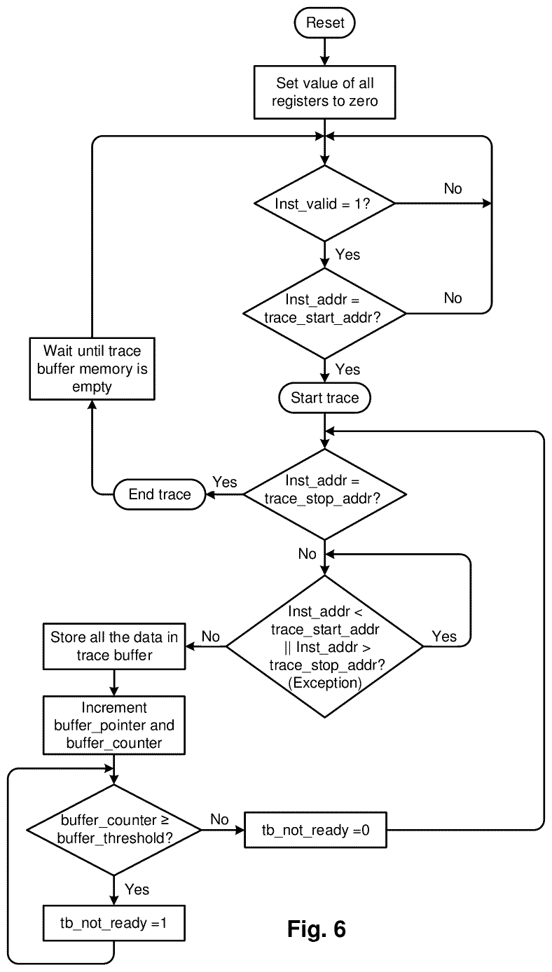

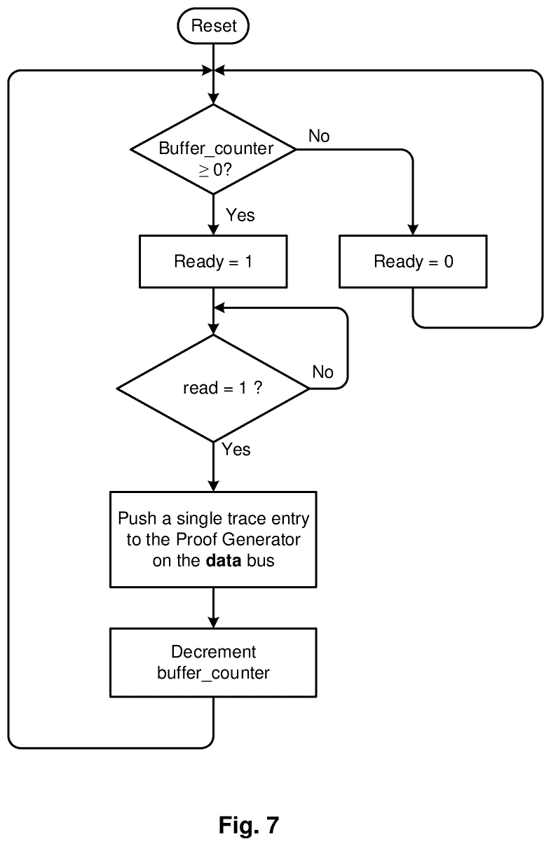

Clearly buffer_threshold is necessary only in implementations where the trace buffer memory does not have sufficient capacity to accommodate the complete trace. In some embodiments, the trace buffer memory is implemented by means of a FIFO, which stores trace data sequentially by means of a pointer that resets when data is written to the last addressable location in the memory. This is explained in more detail with reference to FIG. 5 below.
Write_buffer_pointer: points to the address in the trace buffer memory where to write the next valid instruction data from the CPU core. This register is not accessible by the user and is cleared upon reset.
Read_buffer_pointer: points to the address in the trace buffer memory from where the proof generator must read the next valid instruction data. This register is not accessible by the user and is cleared upon reset.
Buffer_valid_entries_counter: counts the number of the unread traced instructions in the trace buffer memory. This register is continuously compared every clock cycle with the buffer_threshold register in order to assert/negate the tbm_not_ready signal. The Buffer_valid_entries_counter register is not accessible by the user and is cleared upon reset. For simplicity, the Buffer_valid_entries_counter is abbreviated to buffer_counter in FIGS. 6 and 7.
Zkp_read_batch_size: this is an optional parameter set by the user as part of the configuration and holds the size of the batch in Trace_buffer entries that the proof generator receives on each read operation. If the Last Entry bit is asserted in the middle of the burst, the Trace Buffer logic generates data cycles with zero data value till the end of the burst.

A zk-proof trace may contain states corresponding to several million instructions, which may greatly exceed the capacity of the trace buffer memory. It is therefore necessary periodically to halt execution of the main program and flush the contents of the trace buffer memory to the proof generator, whereupon program execution can continue. The proof generator 12 has sufficient memory to accommodate the complete trace, which may be stored in RAM or DRAM or even on disk for access by the proof generator via the peripheral bus 20.

There are many valid possible ways to implement the interface between the proof generator and the trace buffer module. In overview, data is pushed by the trace buffer module to the proof generator when it is ready to receive data. In some embodiments, multiple records are transferred in batches, the size of which is determined by Zkp_read_batch_size. When the trace buffer module has the requisite number of records in its memory, its ready signal goes HIGH and when the proof generator is ready to receive data, it asserts a read signal toward the trace buffer module. This signal is asserted once per data transfer or batch. The trace buffer module then pushes the data toward the proof generator on the data bus. The proof generator is not itself part of the present invention, it being sufficient to note that until the read signal is received by the trace buffer module it retains all currently stored trace data in the trace buffer memory pending receipt of the read signal. If, as a result of not flushing data to the proof generator, the trace buffer memory becomes full, the trace buffer module will set the tbm_not_ready signal to HIGH, which will interrupt execution of the proof program by the CPU core.

In an alternative embodiment, data is pushed to the proof generator one record at a time, in which case Zkp_read_batch_size defaults to one and is not required.

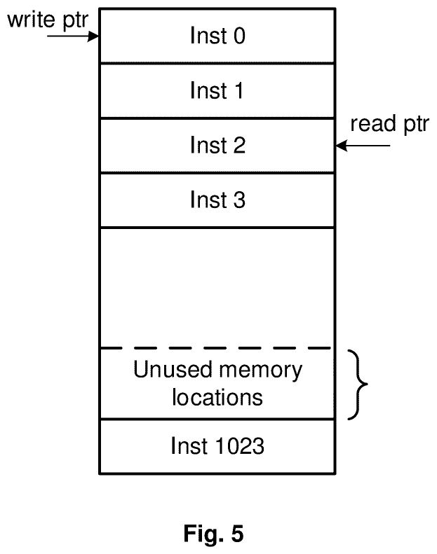

FIG. 4 shows the structure of each state stored in the trace buffer memory. Each record or state comprises the following fields:
Instruction Address—address of the instruction in the program memory
Opcode—opcode of the instruction with all its fields. Based on the opcode the Proof Generator could decide which register was altered by the instruction.
Register/Store Data Value—a new value of the register
Load/Store Address—address of the data of the load/store instruction.
Change of flow—change of the traced program flow. That includes taken/not taken branches, function calls and returns etc.
Last Entry bit is asserted for the last entry of the trace (last executed instruction of the traced program). Note that if the last instruction is a branch instruction, the trace is not stopped. It is needed in order to recognize the execution of various system exceptions.

FIG. 5 shows schematically an implementation of the trace buffer memory in the form of a FIFO to which the trace logic writes data and the proof generation logic reads data. Write_ptr refers to write_buffer_pointer and read_prt refer to read_buffer_pointer as described above. When the trace buffer memory is ready to receive data, each new record is written to the memory location addressed by write_buffer_pointer. Conversely, when the proof generator is ready to receive data, each new record is read from the memory location addressed by read_buffer_pointer. Buffer_threshold establishes a safety zone that allows a batch of trace data records to be written to the trace buffer memory without exceeding the capacity of the memory and serves to interrupt the CPU when the trace buffer memory is approaching full capacity. For example, the memory shown in FIG. 5 has 1024 addressable memory locations and we will assume, by way of example, that Buffer_threshold=992 and that write_buffer_pointer is currently set to 980. If a batch of twenty trace records is now written, these records will spill over beyond Buffer_threshold without exceeding the actual capacity of the trace buffer memory. The difference between write_buffer_pointer and read_buffer_pointer establishes the number of valid entries in the trace buffer memory that remain to read by the proof generator.

In the above-described implementation, the write and read pointers determine the addressable location in the memory to and from which to write and read trace data. In an alternative implementation, the FIFO can be implemented by a shift register, which shifts records every time a record is read so that the first memory location in the FIFO always contains the next record that needs to be pushed to the proof generator. In such an implementation the write and read pointers are not required, and the number of valid entries determines how many shift operations are required until the last entry is shifted to the first memory location.

By way of example, we will now consider all the steps of trace generation for a small program running on RISC-V that calculates 7*(3+4)−30. Within the context of ZK proof, the number may be assumed to be a secret argument known only to the prover. For the purpose of the following description, we will further require that the value ‘3’ will be loaded from memory address 0x2000 and the result will be stored in memory address 0x2008. The assembly and the opcodes of this program looks as follows, it being understood that this example is tailored to RISC-V although the principles apply to any CPU:
#Load the value 3 from memory address 0x2000
0x1000: 0x7D000513 #addi a0, x0, 0x2000
0x1004: 0x00052283 #lw t0, 0(a0)

For the sake of abundant clarity we will explain in detail how this instruction is implemented since similar principles will apply to the rest of the code.
Instruction 1: addi a0, x0, 0x2000 (Immediate Addition)
Machine Code: 0x7D000513
Address: 0x1000

### Breakdown:

addi (add immediate) is an immediate arithmetic instruction.
a0 (register x10) is the destination register.
x0 (hardwired to zero) is the source register.
0x2000 (8192 in decimal) is the immediate value.

### Execution Steps:

1. Fetch: The instruction addi a0, x0, 0x2000 is fetched from address 0x1000.
2. Decode: The opcode and operands are extracted.
3. Execute: The immediate value 0x2000 is added to x0 (which is 0), resulting in 0x2000.
4. Writeback: The result 0x2000 is stored in register a0 (x10).

### Effect on Registers:

a0 (x10)=0x2000
Instruction 2: lw to, 0(a0) (Load Word)
Machine Code: 0x00052283
Address: 0x1004

### Breakdown:

lw (load word) is a memory load instruction.
t0 (register x5) is the destination register.
0(a0) means loading from memory at address stored in a0 (which is 0x2000).
Offset 0 means no displacement is added to a0.

### Execution Steps:

1. Fetch: The instruction lw t0, 0(a0) is fetched from address 0x1004.
2. Decode: The opcode and operands are extracted.
3. Address Calculation: Since a0=0x2000, the effective memory address to read from is 0x2000.
4. Memory Read: The value stored at address 0x2000 in memory is read. We shall assume the memory at 0x2000 holds the value 3.
5. Writeback: The value 3 is written into register to (x5).

### Effect on Registers:

t0(x5)=3

### Final Outcome

a0 (x10)=0x2000 (Holds the memory address)
t0 (x5)=3 (Loaded value from memory at 0x2000)

Having described the manner in which RISC-V instructions are handled at the compiler level, we will now describe the remaining instructions that are executed in our simple program and show the effect on the registers.
#Load constants
0x1008: 0x00400313 #addi t1, x0, 4
0x100C: 0x00700393 #addi t2, x0, 7
0x1010: 0x01E00E13 #addi t3, x0, 30

These instructions place the constant 4, 7 and 30 into registers t1, t2 and t3, respectively.
#Perform calculation
0x1014: 0x00628233 #add t0, t0, t1
0x1018: 0x02728233 #mul t0, t0, t2
0x101C: 0x41C28233 #sub t0, t0, t3

These calculations are implemented as follows:
Instruction 1: add t0, t0, t1 (Addition)
Machine Code: 0x00628233
Address: 0x1014

### Breakdown:

add (addition) is a basic arithmetic instruction.
t0 (register x5) is the destination register.
t0 (register x5) is the first source register.
t1 (register x6) is the second source register.

### Execution Steps:

1. Fetch: The instruction is fetched from address 0x1014.
2. Decode: The opcode and registers are extracted.
3. Execute: Perform the addition t0=t0+t1.
4. Writeback: Store the result back in t0 (x5).

### Effect on Registers:

If:
t0 (x5)=3 (from lw t0, 0(a0))
t1 (x6)=4 (from addi t1, x0, 4)

Then after execution:
t0(x5)=3+4=7
Instruction 2: mul t0, t0, t2 (Multiplication)
Machine Code: 0x02728233
Address: 0x1018

### Breakdown:

mul (multiplication) is an integer multiplication instruction (from the RISC-V M extension).
t0 (register x5) is the destination register.
t0 (register x5) is the first source register.
t2 (register x7) is the second source register.

### Execution Steps:

1. Fetch: The instruction is fetched from address 0x1018.
2. Decode: The opcode and registers are extracted.
3. Execute: Perform the multiplication t0=t0*t2.
4. Writeback: Store the result back in t0 (x5).

### Effect on Registers:

If:
t0 (x5)=7 (from the previous add instruction)
t2(x7)=7

Then after execution:
t0(x5)=7*7=49
Instruction 3: sub t0, t0, t3 (Subtraction)
Machine Code: 0x41C28233
Address: 0x101C

### Breakdown:

sub (subtraction) is an arithmetic instruction.
t0 (register x5) is the destination register.
t0 (register x5) is the first source register.
t3 (register x28) is the second source register.

### Execution Steps:

1. Fetch: The instruction is fetched from address 0x101C.
2. Decode: The opcode and registers are extracted.
3. Execute: Perform the subtraction t0=t0−t3.
4. Writeback: Store the result back in t0 (x5).

### Effect on Registers:

If:
t0 (x5)=49 (from the previous mul instruction)
t3 (x28)=30 (assuming some prior value for t3)

Then after execution:
t0 (x5)=49-30=19

### Final Outcome:

After executing these three instructions sequentially:
1. t0=t0+t1→t0=3+4=7
2. t0=t0*t2→t0=7*7=49
3. t0=t0−t3→t0=49−30=19

So, the final value of to (x5) is 19.

Finally, we store the result in address 0x2008 and exit by jumping back to the Operating System.
#Store result to memory address 2008
0x1020: 0x7D800593 #addi a1, x0, 0x2008
0x1024: 0x0055A023 #sw t0, 0(a1)
#Exit
0x1028: 0x05D00893 #addi a7, x0, 93
0x102C: 0x00000513 #addi a0, x0, 0
0x1030: 0x00000073 #ecall

Note that there is no change of flow in this program except the last instruction (ecall) that causes a change of flow when the program jumps back to the Operating System upon completion of the program execution.

Let's assume that the depth of the Trace Buffer memory is 4K entries and we would like to stop recording the entries when this memory approaches being full. We will define that this memory is almost full when there are 32 empty entries left in the memory.

Then the Trace Buffer registers are configured by the CPU as follows:
trace_start_address—0x1000
trace_stop_address—0x1030
buffer_threshold—4064 (4K—32)

The remaining registers are initialized as follows:
write_buffer_pointer (next location to write)—0x0
read_buffer_pointer (current location to read)—0x0
buffer_valid_entries_counter—0x0

After execution of the first instruction (addi a0, x0, 0x2000) the values of the following registers will change as follows:
write_buffer_pointer—0x1
read_buffer_pointer—0x0
buffer_valid_entries_counter—0x1

And the value of the entry in the Trace Buffer memory address zero is:

| | | | Register/ | | |
|---|---|---|---|---|---|
| Last | Instruction | | Store | Load/Store | Change |
| Entry | Address | Opcode | Data Value | Address | of Flow |
| 0 | 0x1000 | 0x7D000513 | 0x2000 | 0 | 0 |

Values description:
Last Entry has a value of 0 because it's not the last entry of the trace.
Instruction Address is 0x1000 because the program starts at address 0x1000.
The Opcode of the instruction is 0X7D000513. Based on this opcode the prover can know the register that was updated by the instruction. In this case it's register a0.
Register/Store Data Value is 0x2000 after execution of the instruction.
Load/Store Address is not important for this instruction because the instruction is not of Load/Store type.
Change of Flow is 0 because there is no change of flow caused by the instruction.

Upon completion of the program, the Trace Buffer memory will look as follows:

| | | | Register/ | | |
|---|---|---|---|---|---|
| Last | Instruction | | Store | Load/Store | Change |
| Entry | Address | Opcode | Data Value | Address | of Flow |
| 0 | 0x1000 | 0x7D000513 | 0x2000 | 0 | 0 |
| 0 | 0x1004 | 0x00052283 | 3 | 0x2000 | 0 |
| 0 | 0x1008 | 0x00400313 | 4 | 0 | 0 |
| 0 | 0x100C | 0x00700393 | 7 | 0 | 0 |
| 0 | 0x1010 | 0x01E00E13 | 30 | 0 | 0 |
| 0 | 0x1014 | 0x00628233 | 7 | 0 | 0 |
| 0 | 0x1018 | 0x02728233 | 49 | 0 | 0 |
| 0 | 0x101C | 0x41C28233 | 19 | 0 | 0 |
| 0 | 0x1020 | 0x7D800593 | 0x2008 | 0 | 0 |
| 0 | 0x1024 | 0x0055A023 | 19 | 0x2008 | 0 |
| 0 | 0x1028 | 0x05D00893 | 93 | 0 | 0 |
| 0 | 0x102C | 0x00000513 | 0 | 0 | 0 |
| 1 | 0x1030 | 0x00000073 | 0 | 0 | 1 |

Note that in the last entry the Last Entry value is 1 because it is the last instruction of the program and Change of Flow is 1 because there is a change in the flow of the program.

FIGS. 6 and 7 are flow charts that shows the principal operations of an algorithm that controls the trace buffer module. It is to be understood that in the context of the invention, the trace buffer module operates as a finite state machine whose operation is defined by the logic of FIGS. 5 and 6, although the actual hardware implementation is determined by a hardware engineer. The CPU generates the binary code of the program to be traced, loads it into its memory, thereby enabling the user to configure the trace_start_address and trace_stop_address registers. During configuration, the user also assigns buffer_threshold and optionally Zkp_read_batch_size, each of which may be stored in registers inside the trace buffer module for fast access. The CPU starts the execution of the program by jumping to its start address. Trace Buffer logic identifies that the program run has been started by comparing the instruction address to trace_start_address and starts to record all the needed data. If, during program execution, the CPU encounters an interrupt or exception (such as an MMU page miss), the Trace Buffer logic detects that the interrupt or exception code falls outside the recorded execution range. As a result, it pauses recording until the traced program resumes. One of the CPU interrupts may be connected to tbm_not_ready signal generated by the Trace Buffer logic. When this interrupt is asserted (it happens when buffer_valid_entries_counter register is greater than buffer_threshold register), the CPU jumps to the corresponding interrupt handler and continuously reads the buffer_valid_entries_counter register of the Trace Buffer. Once this value drops to a sufficiently low level, program execution can safely continue. When the Trace Buffer recognizes that the CPU executed the last instruction of the program it stops the recording. It stays in this state until the Proof Generator finishes reading all the data from the Trace Buffer memory, when it returns to the Reset state.

The logic depicted in FIGS. 6 and 7 is implemented by a hardware state machine using logic gates. There are three states each corresponding to the output of a corresponding one of the three decision boxes. When any state is activated, the corresponding logic in the flow chart is executed.

### The Verifier

The verifier is not itself part of the present invention, but for the sake of completeness, we will provide a basic description of its functionality since it needs to be able to authenticate the prover. As noted previously, it is essential that the same compiler be used for both the prover and the verifier. It does this using the proof received from the proof generator in conjunction with the same program executed by the prover. However, the manner in which this is achieved may be slightly different depending on the application and this can impact the data that is conveyed by the proof generator to the verifier. This, in turn, may impact the data that is constructed by the proof generator and hence the data that needs to be conveyed by the witness generator to the proof generator. Therefore, in order to understand how the invention can be adapted to work in all possible scenarios, some basic introduction to the operation of the verifier is required.

Essentially, the prover executes a public program using a secret input argument known only to the prover and, after proof generation, conveys the proof to the verifier. The verifier runs the same program using the received proof as input, and is thereby able to establish whether the prover is authentic.

The public program is a deterministic function ƒ(x) that constructs a Merkle tree. A Merkle tree is a binary tree where leaf nodes store hashed values of the original data, intermediate nodes store hashes of their child nodes, and the final or root node is a hash value that represents the entire dataset securely.

Each node's hash is computed as H=Hash(L∥R) where:
L is the left child's hash,
R is the right child's hash,
∥ denotes concatenation.

This structure allows verification of a data element without revealing the entire dataset provided that the verifier has access to:
The final root hash stored publicly.
The same hashing function ƒ(x) as the prover.
The Merkle proof path used by the prover.

The verifier starts from a known leaf node. In response to a challenge by the verifier, which of course cannot be predicted in advance by the prover, the prover provides a specific data element queried by the verifier and of which the prover claims to have knowledge. The verifier hashes this element to get a leaf hash and reconstructs the path up the Merkle tree. In some applications, the prover supplies intermediate hashes while in others the verifier constructs the intermediate hashes from the public function ƒ(x). In either case, the verifier iteratively hashes using the same function H=Hash(L∥R) and the proof itself (i.e., the final hash) is sufficient because the verifier can infer the Merkle path rather than receive it explicitly. The verifier establishes that the prover is authentic if the computed root matches the known root.

It is important in this context to appreciate that, in order to reconstruct the Merkle tree, the verifier must either have access to the same function ƒ(x) as the prover, or must be receive the Merkle tree from the proof generator. Specifically, in the case that the public program deterministically defines how the Merkle tree is built, the verifier can reconstruct the proof path without needing it from the prover. The same secret input will always produce the same proof path. So, if the public program dictates how the tree is constructed, the verifier can compute the intermediate hashes itself.

For example, consider that the prover runs a public function:

MerkleRoot=ƒ(secret input)

The verifier, knowing ƒ(x), can independently compute the same Merkle tree. Since the verifier can rebuild the tree step-by-step, it does not need the prover's proof path. In this case, the public program is a deterministic function ƒ(x) that constructs the Merkle tree. Given the proof (final hash), the verifier recomputes the entire tree using ƒ(x). If the recomputed Merkle root matches the expected root, the proof is valid.

On the other hand, the Merkle proof path (i.e., the set of intermediate hashes needed to reconstruct the root) is required when the verifier does not have access to the original dataset (only the prover does), and the verifier only knows the final Merkle root and needs proof that a specific element belongs to it. This is common in blockchain applications like Bitcoin's SPV proofs (Simple Payment Verification), where light nodes verify transactions using Merkle proofs from full nodes.

The present invention accommodates both scenarios, but must be configured accordingly. In other words, the trace buffer module must be configured to provide the Merkle proof path or sufficient data to allow the proof generator to determine the Merkle proof path and feed it, together with the Merkle root (i.e. the proof) to the verifier; or, alternatively, assume that the verifier has full (public) access to the function ƒ(x) and can therefore derive the Merkle tree on its own. What this means, in practice, is that in applications where the verifier has full access to the function ƒ(x), the trace stored in the trace buffer memory need only record the states of the registers after each successive instruction. But in applications where the verifier does not have access to the function ƒ(x), it needs to be provided with the Merkle tree or with data that will enable the verifier to construct the Merkle tree.

As noted, the above description is not directly germane to the present invention, which relates only to witness generation. But it is indirectly germane because the witness is of no use unless the proof generator and the verifier are both able to function, and the considerations pertaining to the verifier apply also to the proof generator. To this extent, if the function ƒ(x) is accessible to the proof generator, then it is sufficient for the witness to record only the results of each successive instruction. But if not, then the witness must also store for each result the corresponding instruction opcode and associated arguments in order to allow the proof generator to replicate the Merkle tree.

It should be noted that features that are described with reference to one or more embodiments are described by way of example rather than by way of limitation to those embodiments. Thus, unless stated otherwise or unless particular combinations are clearly inadmissible, optional features that are described with reference to only some embodiments are assumed to be likewise applicable to all other embodiments also.

1. A hardware trace buffer module having connections for coupling to a processor that is configured to run a zero-knowledge virtual machine, the trace buffer module being configurable by a prover to store data identifying traceable instructions executed by the processor that are to be traced for use by a proof generator, the trace buffer module being responsive to completion of successive instructions executed by said processor, for accessing memory in the processor and for each traceable instruction recording a respective state of the processor in a trace buffer memory of the trace buffer module, the trace buffer module being couplable to a proof generator configured to compute a proof from the successive states in the trace buffer memory.

2. The trace buffer module according to claim 1, integrated on a die that forms a unitary circuit with the processor.

3. The trace buffer module according to claim 1, wherein the processor is an open source processor.

4. The trace buffer module according to claim 1, wherein upon completion of each instruction executed by the processor, the instruction is stored in the trace buffer memory together with a corresponding state of the memory.

5. The trace buffer module according to claim 1, including an inst_valid input that is connected to an instruction register in the CPU and goes from a first logic state to a second logic state in response to completion of an instruction for storing in the trace buffer memory trace data relating to a register whose content was changed by the instruction.

6. The trace buffer module according to claim 1, wherein the data identifying traceable instructions includes start and stop addresses that identify an address block each of whose constituent addresses points to a respective instruction that requires tracing.

7. The trace buffer module according to claim 1, wherein the trace data includes an opcode and arguments associated with the instruction.

8. The trace buffer module according to claim 1, including a tbm_not_ready output that goes from a first logic state to a second logic state in response to the trace buffer memory being unable to accommodate more data and that is reset to the first logic state when the trace buffer memory is cleared.

9. The trace buffer module according to claim 8, including a Buffer_threshold used to generate the tbm_not_ready signal in order to suspend the execution of the traced program until the trace buffer module has enough free space to continue the trace.

10. The trace buffer module according to claim 1, including a Write_buffer_pointer that points to a trace buffer entry where to write a next valid instruction data.

11. The trace buffer module according to claim 1, including a Read_buffer_pointer that points to a trace buffer entry from where to read a next valid instruction data.

12. The trace buffer module according to claim 8, including a Buffer_valid_entries_counter that counts a number of unread traced instructions in the Trace Buffer and establishes a maximum number of instructions that can be traced before asserting the tbm_not_ready signal.

13. The trace buffer module according to claim 1, including a Zkp_read_batch_size memory that stores the size of a batch of trace entries that are fed to the proof generator in a single transfer of data.

14. The trace buffer module according to claim 1, being coupled to a Reorder buffer in the CPU via a FIFO that is configured to store multiple instructions and compensates for bursts of committed instructions arriving from the Reorder buffer to the trace buffer module that cannot be immediately accommodated by the trace buffer memory.

15. The trace buffer module according to claim 1, integrated on a die that forms a unitary circuit with the proof generator.
